(19) United States
(12) Patent Application Publication
(10) Pub. No.: US 2012/0323352 A1
(43) Pub. Date: Dec. 20, 2012

(54) SINGULAR AND CO-MOLDED PRE-FORMS

(76) Inventor: Lauren Groth, Cypress, TX (US)

(21) Appl. No.: 13/160,795

(22) Filed: Jun. 15, 2011

(51) Int. Cl. G06F 17/50

(52) U.S. Cl. 700/98

(57) ABSTRACT

Molded pre-forms that are used to protect electronic components and assemblies from damage due to vibration, shock and/or thermal exposure. The pre-forms can be singularly molded or co-molded. Co-molded pre-forms can include hard surface layers over softer molded compositions. The pre-forms are molded in molds that are formed using modified images obtained from printed circuit boards having the electronic components thereon. Images of the printed circuit boards are obtained and modified to improve vibrational dampening and/or heat transfer. The molded pre-forms allow for access to the printed circuit boards for purposes of replacing or repairing the printed circuit boards.

### TECHNICAL FIELD

The present invention relates to protecting electronic components and assemblies from damage due to vibration, shock and/or thermal exposure. More particularly, the present invention is directed to the production and use of molded pre-forms and their use to protect electronic components and assemblies from damage due to vibration, shock and/or thermal exposure.

### BACKGROUND ART

Electronic component assemblies that are used in “down hole” applications in oil and gas well drilling logging and measurement activities are an extreme example of electronic component assemblies that are subject to significant vibration and shock which are present in the drill string axial direction, along both transverse axes, and rotational acceleration about the axis and high heat/thermal exposure. The electronic component assemblies survive long hours down hole only if: (1) the mounting support offers protection from acceleration induced forces that cause relative strain between components and (2) there is a sufficient heat conduit in place to transfer the heat generated by the printed circuit board assembly (PCBA) so that PCBA damage does not occur. Failures result too often and have serious economic consequences since, unlike other applications of electronic component assemblies and applications thereof, electronic component assemblies in down hole applications can fail far down while drilling and have to be recovered for repair.

Known mounting methods for electronic components such as printed circuit boards involve the use of support structures called “Subs” and or chassis and suspending the assemblies supported thereon in confining, pressure proof, enclosures. The pressure proof enclosures are attached to drill strings to which drill bits are attached or wire line strings where there is no drill bit attached. During a drilling operation, the drill strings are the origin of the most serious shock and linear vibration. The acceleration forces generated during drilling are transmitted by way of the drill string to the enclosure and the attached “Sub” or chassis to the electronic assembly and components. Failure of the electronic component assemblies results when: (1) the acceleration forces cause relative motion between PCBAs and their attached components and or (2) high heat/thermal exposure damages the PCBA since there is no conduit in place to pull the heat from the PCBA and transfer it out.

Two currently used mounting options include: (1) attachment of PCBAs to strongbacks with screws with a sheet of elastomer captured between PCBAs and strongbacks and; (2) positioning PCBAs in openings, or cavities, in “Subs” and filling the remaining volume with elastomer that is cast and cured in place (a type of potting method). A method used more frequently involves placing a PCBA in a mold (that accurately fits the geometry of the cavity in the “Sub”) and casting or encapsulating the PCBA with an elastomer. After curing the encapsulated PCBA is removed from the mold and inserted into the cavity in the “Sub” or directly into the confining structure such as a pressure barrel. In both cases the chassis and or “Sub,” with the electronic assemblies in place, is inserted in the bore of a confining structure, such as a tubular pressure barrel. In many cases the electronic assembly (encapsulated PCBA) is placed directly into a confining structure cavity, such as a pressure barrel.

The first mounting option causes stress concentrations at the screws where acceleration forces are transmitted from the chassis and/or “Sub” to the PCBAs. In addition, temperature changes cause relative thermal expansion between PCBAs and “Subs” or chassis and strains the screw attachment points.

The second mounting option provides cushioning for all components against acceleration forces delivered through the strongback. However, differential thermal expansion between the elastomer and “Sub” causes forced migration of elastomer in unpredictable amounts and directions. As a result, destructive strains force relative movement between PCBA and attached components.

U.S. Pat. No. 4,891,734 to More et al. provides a mounting option that is based upon the premise that the ideal support for electronic components will cushion all components about equally, will allow inevitable elastomer migration, very localized, in known directions and in known amounts, and that small movements allowed by cushioning can be accommodated by free moving conductors sufficiently short and supported to prevent their becoming a vibrating independent mass.

U.S. Pat. No. 4,891,734 to More et al. discloses enclosing electronic assemblies in elastomeric bodies that are separately molded to fit the confining enclosures of strongbacks that are provided with cavities for the elastomeric bodies and configured to be received in tubular shrouds. The electronic assemblies are positioned in molds shaped to represent the cavities of the strongbacks and elastomeric material is cast around the assembly. Only a connector is exposed at the elastomer surface.

Potting or encapsulating electronic components to protect them from vibration, shock and/or thermal exposure has been used for individual components, component assemblies, PCBAs, circuit boards, etc. in all types of applications. A major disadvantage associated with potting an encapsulation processes is that it is difficult to access and repair electronic components that are potted or encapsulated. While it is possible remove electronic components from potting and encapsulating materials, such processes are prohibitly tedious. The general practice is to merely replace rather than repair potted or encapsulated electronic components. Accordingly, it is not practical to pot or encapsulate components that are desired to be repaired rather than replaced. The only options for protecting such components from vibration, shock and/or thermal exposure is to flat pad, tape down, or mechanically secure such components.

U.S. Pat. No. 7,357,886 and U.S. Patent Application Publication No. 2006/0043635 both to the present inventor are directed to molded pre-forms that are used to protect electronic components and assemblies from damage due to vibration, shock and/or thermal exposure. The molded performs are produced by a method in which electronic components and assemblies are scanned to produce an electronic image which is subsequently used to fabricate a mold form that is used to mold the pre-forms.

The present invention provides molded pre-forms, methods to fabricate the molded pre-forms, and their use to protect electronic components and assemblies from damage due to vibration, shock and/or thermal exposure. Exemplary applications include down hole use in drill strings in wells, computer boards, printed circuit boards, computer modules and particularly portable computers and electronic components, automotive electronics, aerospace electronics and military electronic to mention a few.

### DISCLOSURE OF THE INVENTION

According to various features, characteristics and embodiments of the present invention which will become apparent as the description thereof proceeds, the present invention provides a method of protecting a printed circuit board assembly (PCBA) from at least one of vibration, shock and, the method involving:

providing a PCBA that includes a plurality of electrical components;
fabricating a molded pre-form by the steps of:
a) producing a CAD PCBA database that comprises a collection of the electronic image data of each of the plurality of electrical components, the CAD PCBA database produced by at least one of:
   i) separately creating an electronic image data of individual ones of the plurality of electrical components;
   ii) obtaining electronic image data of individual ones of the plurality of electrical components from a supplier or manufacturer of said electrical components;
   iii) obtaining electrical image data of individual ones of the plurality of electrical components from a database; and
   iv) obtaining electrical image of the PCBA by using a 3-D scanner.
b) modifying the produced CAD PCBA database to produce a tooling database;
c) fabricating a mold from the tooling database; and
d) molding a pre-form that is substantially complementarily shaped to a first portion of the PCBA; and

securing the PCBA within the pre-form to protect the electrical components from damage caused by at least one of vibration, shock and thermal effects.

The present invention further provides a method of fabricating a molded pre-form used to protect a printed circuit board assembly (PCBA) which method involves the steps of:

a) providing a PCBA having a plurality of electrical components having different shapes;

b) producing a CAD PCBA database that comprises a collection of the electronic image data of each of the plurality of electrical components, said CAD PCBA database produced by at least one of:
i) separately creating an electronic image data of individual ones of the plurality of electrical components;
ii) obtaining electronic image data of individual ones of the plurality of electrical components from a supplier or manufacturer of said electrical components; and
iii) obtaining electrical image data of individual ones of the plurality of electrical components from a database;
iv) obtaining electrical image of the PCBA by using a 3-D scanner.

c) modifying the produced CAD PCBA database to produce a tooling database;

d) fabricating a mold from the tooling database; and

e) molding a pre-form that is substantially complementarily shaped to a first portion of the PCBA.

### BRIEF DESCRIPTION OF DRAWINGS

The present invention will be described with reference to the attached drawings which are given as non-limiting examples only, in which:

FIG. 1 is a flowchart which shows the steps involved in fabricating single molded and co-molded pre-forms according to one embodiment of the present invention.

FIG. 2 depicts an image of a PCBA that was developed using computer-aided design (CAD) software and techniques.

FIGS. 3a-3d show a set of four molds that were made according to the present invention.

FIG. 4 shows a singular molded pre-form, with seated PCBA in an open positioned, produced according one embodiment of the present invention.

FIG. 5 shows a co-molded perform in an open position having a PCBA therein.

FIG. 6 shows a co-molded perform in a closed position with a PCBA therein.

FIG. 7 is a cross-sectional view of a section of a co-molded pre-form according to the present invention.

### BEST MODE FOR CARRYING OUT THE INVENTION

The present invention is directed to molded pre-forms, methods for fabricating the molded pre-forms, and the use of the molded pre-forms to protect electronic components and assemblies from damage due to vibration, shock and/or thermal exposure. Exemplary applications include down hole use in drill strings in wells, computer boards and particularly portable computers and electronic components, automotive electronics, aerospace electronics and military electronic to mention a few.

The molded pre-forms of the present invention are made from virtually any injectable material such as elastomers that can be molded and are sufficiently heat resistant and suitable for absorbing anticipated vibration and/or shock. The injectable material such as elastomers that are thermally conductive can be used to transfer heat from electronic components to chassis or other support structures, heat sinks, cooling structures, etc. Exemplary injectable materials include silicone based compositions with platinum based silicones being one particular example. The thermally conductive elastomer identified as 3-6655 and available from Dow Corning was determined to be particularly useful for purposes of the present invention. Another composition from Dow Corning identified as 3-6751 is a thermally conductive adhesive which was used to produce the hard thin outer layer. (It was not mixed with 3-6655). Other exemplary injectable materials include urethane compositions and visco elastomeric materials, including visco elastomeric materials that are modified by adding fillers such as fiberglass strands to enhance performance.

The present invention provides several types of molded pre-forms including those that are not reinforced, those that are reinforced by adding therein materials such as fiberglass scrim weave, carbon fibers, fiberglass structures those that are reinforced by embedding inserts therein, and those that are co-molded so as to have two or more layers having different properties. Examples of embedded inserts include metal mesh and metal foils which can provide for EMI shielding, and heat sinks including cables, wires, pins and other metal structures.

The pre-forms of the present invention were initially designed for use in conjunction with printed circuit boards (PCBA) and other electronics packaging systems which, when in use, are subject to vibration and/or over heating. Although the pre-forms of the present invention are described herein for exemplarily purposes with reference to “down hole” applications, it is to be understood that the pre-forms of the present invention can be used in conjunction with virtually any PCBA or electronic component or electronics package or assembly, etc., including computer boards and electronic components in both portable and non-portable computers, automotive electronic systems, aerospace electronic systems and military electronic systems to mention only a few.

As noted above, various embodiments of the present invention include singular molded pre-forms (also referred herein as simply “molded pre-forms), and co-molded performs.

Singular molded pre-forms are molded from one elastomer or injectable molding composition such as in the case of “down hole” application a thermally conductive material with shock damping characteristics or vice versa. Singular molded pre-forms lay like a blanket over a PCBA to act as a: (1) path (conduit) to transfer heat from the PCBA to a chassis, Sub or other structure; and (2) “sponge” to absorb vibration. Note: lay like a blanket with clearance between the preform and the components.

Co-molded pre-forms were developed according to the present invention to better facilitate the use of elastomer of other injectable molding materials that after molding may be soft and “sticky” and therefore difficult to slide into an enclosure or assembly. Otherwise, the molded materials may be easily damage during handling because of their softness.

Co-molded pre-forms are molded from/with two or more materials. Co-molded pre-forms can use the same singular molded material to blanket a PCBA (to provide vibration damping and/or thermal conduit); however, they also have a hard outer thin shell that facilitates sliding or handling of a resulting enveloped PCBA into an enclosure or assembly.

The molded and co-molded pre-forms of the present invention provide a convenient alternative to potting and encapsulation techniques. One particular aspect of the present invention is that the molded and co-molded pre-forms are easily removed and re-applied, allowing repair or replacement of individual electronic components or entire PCBAs. Potted and encapsulated PCBAs and electronic components are typically replaced rather than repaired, because the individual components are not accessible through the potting or encapsulation materials.

As will be understood from the description of the invention which follows, the molded and co-molded pre-forms of the present invention can be selectively configured to be optimized for heat management or for vibration or shock damping.

According to one embodiment, the molded and co-molded pre-forms of the present invention are fabricated by a unique process which involves producing an electronic image of a PCBA and using the electronic image to fabricate a set of molds which are configured to match the shape of the PCBA and dimensionally configured to optimize heat management and/or vibration or shock damping. The electronic image of the PCBA, also referred to as a CAD PCBA database, is produced by combining separate electronic data images (or shape and dimensional information) of each of the separate electronic components of a PCBA, such as resistors, capacitors, diodes, etc. The data images of each of the electronic components can be obtained by: i) separately creating an electronic image data of individual ones of the plurality of electrical components; and/or ii) obtaining electronic image data of individual ones of the plurality of electrical components from a supplier or manufacturer of said electrical components; and/or iii) obtaining electrical image data of individual ones of the plurality of electrical components from a database; and/or iv) obtaining electrical image of the PCBA by using a 3-D scanner. This approach is more accurate than previous attempts of imaging a PCBA and can be performed by CAD software programs.

The fabricated molds are used to injection mold the molded pre-forms and the co-molded pre-forms. According to one embodiment of the present invention which is discussed in detail below, a single set of two molds can be used to form a single molded pre-form or a single set of three molds can be used to form a co-molded pre-form for a given PCBA. It is to be understood that the present invention is not limited to injection molding. The molded pre-forms and co-molded pre-forms can made by any combination of molding techniques, including but not limited to injection molding, spray molding, pour molding, etc.

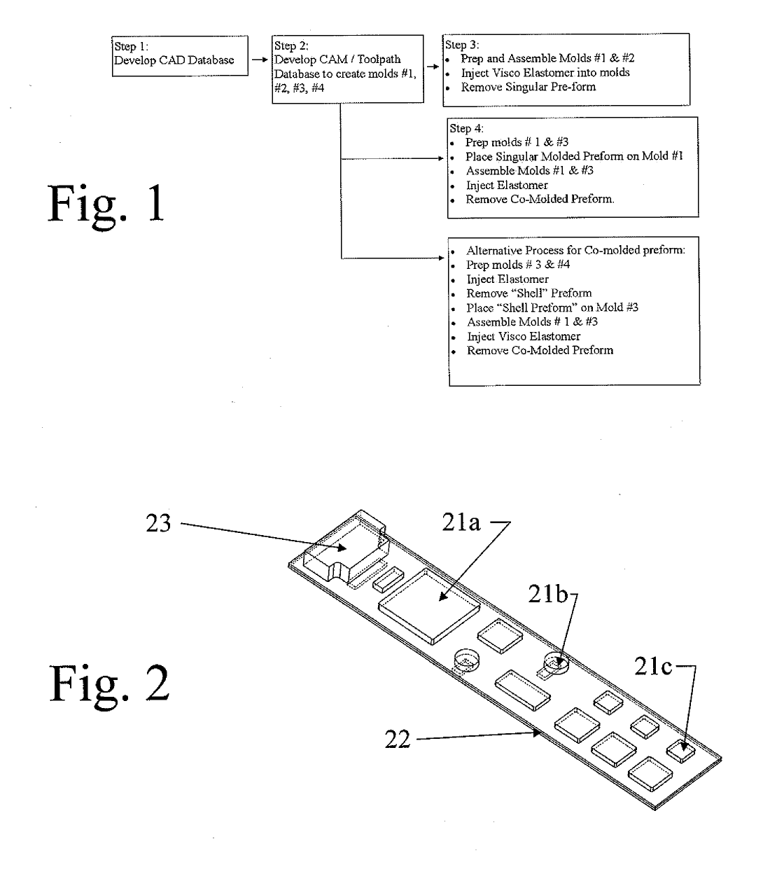

FIG. 1 is a flowchart which shows the steps involved in fabricating single molded and co-molded pre-forms according to one embodiment of the present invention.

In step 1 an electronic image of a PCBA is produced. According to the present invention an electronic image of the PCBA (or CAD PCBA database) is developed using one of at least three methods. According to a first method the CAD PCBA database is built-up or created by creating a composite of each of the individual components or parts of the PCBA. According to a second method the CAD PCBA database is created by importing electronic image information of each of the individual components as assemblies (from manufactures) using a CAD program such as CircuitWorks® (Dassault Systems SolidWorks Corp., Concord. Mass.). Other CAD programs having similar features can also be used. According to a third method an electronic image of a PCBA is obtained by scanning the PCBA with a 3-dimensional scanner.

In more detail, according to the first method of developing or creating a CS PCBA database, each component, chip, connector, and so on is created electronically and accurately placed on a base board so as to accurately represent the actual PCBA. The image of the PCBA in FIG. 2 depicts various electronic components 21a, 21b, and 21c . . . 21x which are mounted on the printed board 22. As depicted, the electronic components 21a, 21b, and 21c . . . 21x have different shapes and sizes which according to the present invention are evaluated and used to produce the molded pre-forms and co-molded pre-forms which conform to the overall configuration of the PCB.

In more detail, according to the second method of developing or creating a CS PCBA database, each component, chip, connector, and so on is imported from the component manufacture and accurately placed on the base board so as to accurately represent the actual PCBA. The image of the PCBA in FIG. 2 depicts various electronic components 21a, 21b, and 21c . . . 21x which are mounted on the printed board 22. As depicted, the electronic components 21a, 21b, and 21c . . . 21x have different shapes and sizes which according to the present invention are evaluated and used to produce the molded pre-forms and co-molded pre-forms which conform to the overall configuration of the PCB.

In step 1 the electronic image of the PCBA (or CAD PCBA database) is manipulated by a computer program to produce tooling database that is subsequently used to create mold forms. During the course of the present invention a software program called SolidWorks® (Dassault Systems SolidWorks Corp., Concord. Mass.) was used to manipulate the CAD PCBA database and produce tooling database. For example, the component geometry 21a, 21b, 21c and 22 can be manipulated by adding clearance to each side of the components to accommodate for elastomeric thermal expansion which can crush the components and cause failure as the temperature rises and the material expands. Also, this additional clearance helps accommodate for any allowable tolerance deviation placement of components during the PCBA manufacturing process. This clearance space which can be larger will compensate for variances in the position of the electrical components on similar PCBAs which may vary. Usually 0.02″ to 0.06″ of clearance (however this can be more or less) is added to each side of the components. The height of each component is measured. If thermal heat transfer/dissipation is the principle concern, the heights of the components in the CAD image/database are manipulated to ensure direct contact with the elastomeric material when under full operating temp. The manipulation or adjustment will help ensure the mold will produce a singular or co-molded pre-form that puts a pre-load on the top of each component and establishes a direct path for the heat to transfer.

If vibration isolation and shock damping are the principle concerns, the heights of the components in the CAD image/database are manipulated by adding about 0.03″ or more to the measured heights of the components. In addition, to help that the PCBA is held firmly in place, while under heavy vibration, while putting no stress on the components a pre-load of around 0.01″ to 0.02″ is added the areas in direct contact with the board FIG. 2 item 22.

In step 2 the modified CAD PCBA database or tooling database is used to fabricate molds for molding the molded pre-forms and co-molded pre-forms. There are a number of computer programs available that can control the operation of machining equipment such as mills, rapid prototyping machines, silicon tooling machines, etc. that can be used to fabricate molds for the pre-forms. In an exemplary embodiment of the present invention, a computer software program called MasterCam® used the CAD image file to control a CNC mill which was used to fabricate a set of three molds which can be used to mold molded pre-forms and co-molded pre-forms.

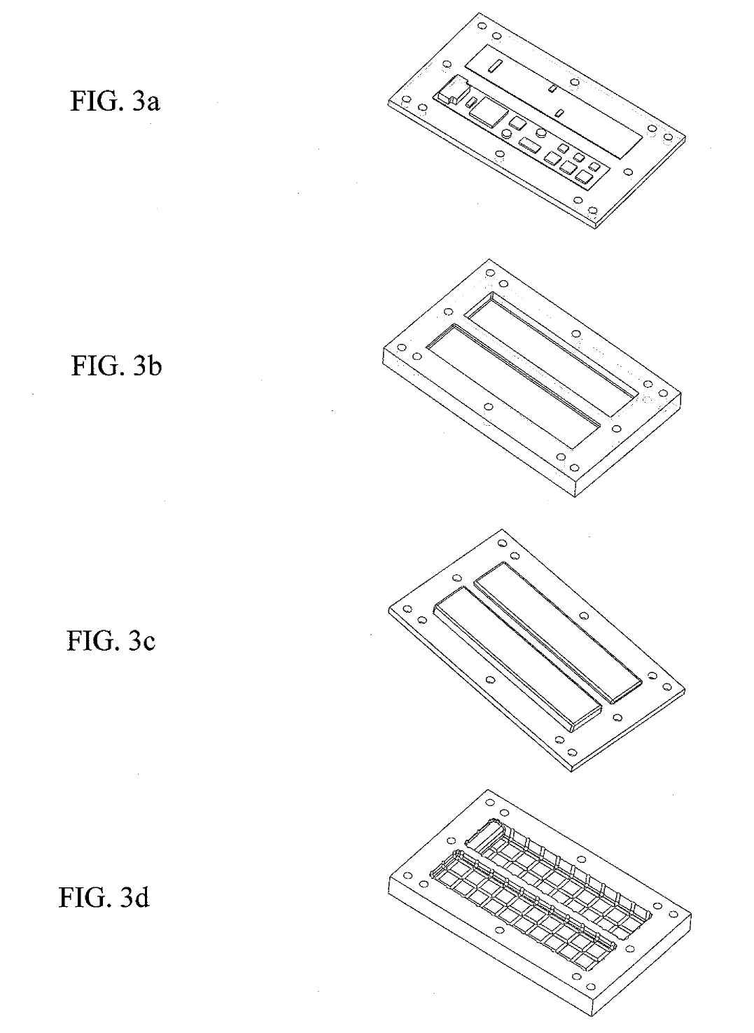

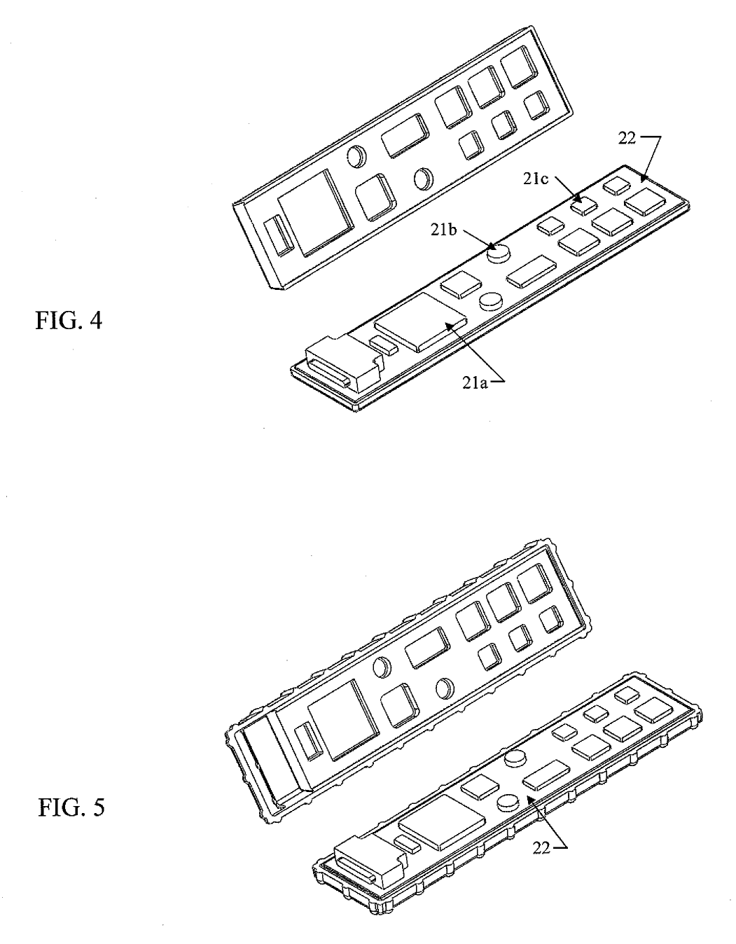

FIGS. 3a-3d show a set of four molds that were made according to the present invention. The first and second molds shown in FIGS. 3a and 3b are used to mold a singular molded pre-form. The first and third molds shown in FIGS. 3a and 3c are used to mold a co-molded pre-form as discussed below. The third and fourth molds shown in FIGS. 4c and 4d are used to mold a thin hard shell for a co-molded perform as explained in detail below.

In step 3 the molds shown in FIGS. 3a and 3b are coupled together and injected with an elastomer composition to form a singular molded per-form.

In step 4 the molds shown in FIGS. 3a and 3c are coupled together with a singular molded pre-form from step 3 is positioned in the resulting mold and a harder curable material is injected within the mold to form a co-molded pre-form.

In an alternative step shown in FIG. 1 molds shown in FIGS. 3c and 3d are coupled together and injected with an elastomer composition to form a thin hard shell primarily for a co-molded perform. Next the molds shown in FIGS. 3a and 3c are coupled together with the thin hard shell positioned in the mold and the mold is injected with an elastomer composition to form a co-molded pre-form.

In order to provide some structural rigidity to the molded pre-form, an insert such as a fiberglass scrim can be placed in the mold assembly before an elastomer composition is injected into the mold assembly. Other insert materials can be used including metal mesh or foil inserts which can provide for EMI shielding. Also, heat sinks, including cables, wires, pins and other metal structures can be embedded into the molded pre-forms. Stiffener materials such as flat, round or tubular configurations can also be added to the elastomer composition to improve the rigidity of the molded pre-forms.

After the elastomer composition (or composition used to form the harder portion of the co-molded pre-forms) is injected into the mold assembly, the mold assembly can be heated as desired to cure the elastomer composition.

The resulting molded pre-forms (remove and co-molded pre-forms) can be removed from the mold assemblies and used “as is.” Alternatively, the molded pre-form can be subjected to an additional molding process to form the co-molded pre-forms of the present invention.

In an exemplary embodiment, a molded pre-form was produced using Dow Corning's 3-6655 elastomer composition and the hard shell was produced using Dow Corning's 3-6751 adhesive composition.

After curing, the molded pre-form and/or co-molded pre-form can be subjected to finishing treatments, including removal of flash trim.

The molded and co-molded pre-forms of the present invention can be in the form of separate pre-forms pieces between which a PCBA is sandwiched or a hinged or connected “clam-shell” structure in which a PCBA is received.

FIG. 4 shows a singular molded pre-form, with seated PCBA in an open positioned, produced according one embodiment of the present invention. In FIG. 4 the molded pre-form above the PCBA is lifted from the PCBA to show the PCBA. FIG.5 shows a co-molded pre-form provided around the PCBA . The overlapping peripheral edges of the molded pre-forms which extend outward beyond the peripheral edge of the PCBA can be sealed together with a suitable adhesive or glue. Alternatively, the PCBA can be secured between the two portions of the molded pre-forms using mechanical means including tape, clips and adjacent support structures.

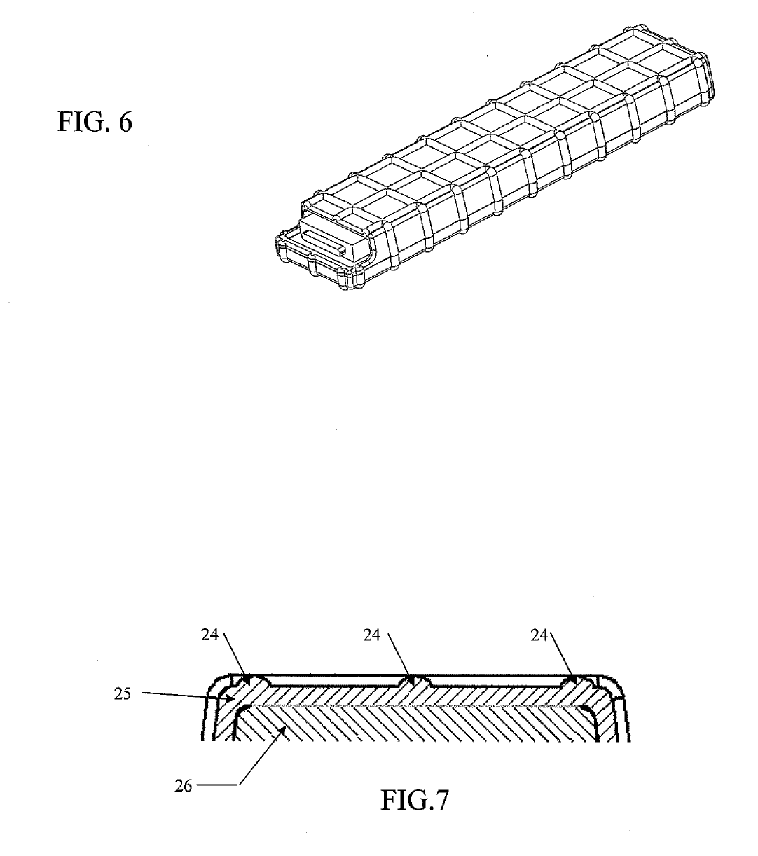

FIG. 5 shows a co-molded perform in an open position having a PCBA therein. As can be seen, the inner surface of the upper portion of the co-molded perform shown in FIG. 6 includes recessed portions which are complementary shaped to the electronic components which are to be received in the recessed portions. As in the case of the molded pre-form shown in FIG. 5, the overlapping peripheral edges of the upper and lower portions of the co-molded pre-form which extend outward beyond the peripheral edge of the PCBA can be sealed together with a suitable adhesive or glue. Alternatively, the PCBA can be secured between the two portions of the co-molded pre-forms using mechanical means including tape, clips and adjacent support structures. The hinge structure between the upper and lower portions of the co-molded (or molded) pre-forms can be reinforced by a scrim or other structure embedded in the pre-molds.

FIG. 6 shows a co-molded perform in a closed position with a PCBA therein. The outer surface of the co-molded pre-form can be provided with ridges. The ridges which will be formed predominately if not exclusively of the composition used to for the hard shell will limit surface area and friction so as to enable the co-molded perform to be slid into an enclosure or assembly. The space between the ridges are used to accommodate thermal expansion also.

FIG. 7 is a cross-sectional view of a section of a co-molded pre-form according to the present invention. FIG. 7 shows ridges 24 that are formed predominately if not exclusively of the composition used to for the hard shell 25. The underlying molded composition is identified by reference number 26 in FIG. 7.

Once sealed, the molded and co-molded pre-forms of the present invention are highly re-enterable. To open the sealed pre-forms, a knife is inserted along the parting line (between the upper and lower halves) and pre-forms are cut open. Once the assembly is opened the PCBA board can be replaced or repaired and the pre-forms can be resealed by using a small amount of adhesive applied along the edges of the pre-molds or by taping the opened edge of the pre-molds closed. The ability to quickly replace and/or repair a PCBA results in a huge cost saving by not having to “trash” the PCBA. Moreover the ability to easily replace the PCBA allows for easy upgrading.

The molded and co-molded pre-forms of the present invention help eliminate or significantly reduce board failure due to thermal expansion of the injectable molded material that is intended to protect the boards. This is accomplished by building a thermal expansion factor (typically 0.03″ to 0.05″) around each component of the PCBA. In addition, since the pre-forms are not mechanically attached to the PCBA, unlike encapsulation, the pre-forms can be removed without occurring damage.

The molding compositions can include conventional additives such as pigments, fillers, etc. Moreover while the molding process is not discussed in undue detail, conventional molding techniques including preparing and cleaning of mold surfaces and the use of release agents can be used in the molding process of the present invention.

As indicated above, the singular molded and co-molded pre-forms of the present invention are suitable for hostile environments in which electronic components, including PCBAs are subject to extreme amounts of vibration, shock and/or thermal exposure. As such, the molded and co-molded pre-forms are useful in applications that involve “down hole” oil and gas well drilling logging and measurement activities. In addition to being useful in extremely hostile environments, the molded and co-molded pre-forms of the present invention are more than adequate for protecting electronic components, including PCBAs in less hostile environments. For example, there are many electronic devices that are designed and constructed for portable, hand-held or field use, including portable computers, hand-held data acquisition devices, communication devices, data and communication up-link devices, global positional devices, remote control devices, etc. In addition, electronic components, including computer modules, other types of PCBAs and other devices are increasingly being used in applications related to transportation such as engine, suspension, braking, climate and other control systems, navigational and onboard diagnostic systems, etc. In the aerospace industry electronic components, including computer modules, other types of PCBAs and other devices are used in avionics electronics, satellite guidance, control and positional systems, aircraft engine controls systems, weapons systems, data recording (“blackbox”) devices, defensive systems, fire suppression systems, etc. The military in increasing using electronic components, including computer modules, other types of PCBAs and other devices in weapons guidance and defense systems, observation and tracking systems, communication systems, etc. Overall electronics that include computers, computer modules, microprocessors, etc. are being adapted for many field and onboard applications which can expose the electron components to adverse heat effects or over heating, shock, vibration, acceleration and other forces that can damage the electronic components if precautionary steps are not implemented. Such applications in transportation devices such as motor vehicles, rail vehicles, aircraft, spacecraft, boats, vessels, etc. are suitable for the type of protection from shock, vibration and/or thermal effects that the molded and co-molded performs of the present invention provides.

The singular molded and co-molded pre-forms of the present invention are particularly suitable for protecting electronic components, including PCBAs, computer modules, power supplies, including batteries, sub-assemblies, etc. in the applications exemplified above. Even in applications that involve minor vibrations such as household appliances, office equipment, and other stationary or transportable apparatus, the molded and co-molded pre-forms of the present invention can be used to protect associated electronic components from shock, vibration and/or heat effects.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A method of protecting a printed circuit board assembly (PCBA) from at least one of vibration, shock and, said method comprising:
providing a PCBA that includes a plurality of electrical components;
fabricating a molded pre-form by the steps of:
a) producing a CAD PCBA database that comprises a collection of the electronic image data of each of the plurality of electrical components, said CAD PCBA database produced by at least one of:
i) separately creating an electronic image data of individual ones of the plurality of electrical components;
ii) obtaining electronic image data of individual ones of the plurality of electrical components from a supplier or manufacturer of said electrical components; and
iii) obtaining electrical image data of individual ones of the plurality of electrical components from a database;
iv) obtaining electrical image of the PCBA by using a 3-D scanner.
b) modifying the produced CAD PCBA database to produce a tooling database;
c) fabricating a mold from the tooling database; and
d) molding a pre-form that is substantially complementarily shaped to a first portion of the PCBA; and
securing the PCBA within the pre-form to protect the electrical component from damage caused by at least one of vibration, shock and thermal effects.

2. A method of protecting a PCBA according to claim 1, wherein molded pre-form includes upper and/or lower molded forms.

3. A method of protecting a PCBA according to claim 1, wherein the upper and lower molded forms of the pre-form are coupled together by a hinge.

4. A method of protecting a PCBA according to claim 1, wherein the pre-form comprises an outer surface layer that is harder than a central portion of the pre-form.

5. A method of protecting a PCBA according to claim 4, wherein the outer surface of the pre-form has ridges formed thereon.

6. A method of protecting a PCBA according to claim 1, wherein an embedded structure of molded into the pre-form.

7. A method of protecting a PCBA according to claim 6, wherein the embedded structure is at least one of a rigid structure, an emi shield and a thermal conductor.

8. A method of protecting a PCBA according to claim 6, wherein the PCBA is used in a down hole application.

9. A method of fabricating a molded pre-form used to protect a printed circuit board assembly (PCBA) which method comprises the steps of:
a) providing a PCBA having a plurality of electrical components having different shapes;
b) producing a CAD PCBA database that comprises a collection of the electronic image data of each of the plurality of electrical components, said CAD PCBA database produced by at least one of:
i) separately creating an electronic image data of individual ones of the plurality of electrical components;
ii) obtaining electronic image data of individual ones of the plurality of electrical components from a supplier or manufacturer of said electrical components; and
iii) obtaining electrical image data of individual ones of the plurality of electrical components from a database;
iv) obtaining electrical image of the PCBA by using a 3-D scanner.
c) modifying the produced CAD PCBA database to produce a tooling database;
d) fabricating a mold from the tooling database; and
e) molding a pre-form that is substantially complementarily shaped to a first portion of the PCBA.

10. A method of fabricating a molded pre-form used to protect a PCBA according to claim 9, wherein the step c) of modifying the produced CAD PCBA database comprises at least one of adding or subtracting a factor to at least the electronic image data of some of the electrical components.

11. A method of fabricating a molded pre-form used to protect a PCBA according to claim 9, wherein molded pre-form includes upper and lower molded forms.

12. A method of fabricating a molded pre-form used to protect a PCBA according to claim 9, wherein the upper and lower molded forms of the pre-form are coupled together by a hinge.

13. A method of fabricating a molded pre-form used to protect a PCBA according to claim 9, wherein the pre-form comprises an outer surface layer that is harder than a central portion of the pre-form.

14. A method of fabricating a molded pre-form used to protect a PCBA according to claim 13, wherein the outer surface of the pre-form has ridges formed thereon.

15. A method of fabricating a molded pre-form used to protect a PCBA according to claim 9, wherein an embedded structure of molded into the pre-form.

16. A method of fabricating a molded pre-form used to protect a PCBA according to claim 9, wherein the embedded structure is at least one of a rigid structure, an emi shield and a thermal conductor.

17. A method of fabricating a molded pre-form used to protect a PCBA according to claim 9, wherein the PCBA is used in a down hole application.

18. A method of fabricating a molded pre-form used to protect a PCBA according to claim 9, wherein the upper and lower molded forms of the pre-form are adhered/glued together.
